(19) United States
(12) Patent Application Publication
(10) Pub. No.: US 2005/0049370 A1
(43) Pub. Date: Mar. 3, 2005

(54) Anti-virus hydrophilic polymeric material

(75) Inventor: Jeffrey Gabbay, Jerusalem, IL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Cupron Corporation, New York, NY (US)

(21) Appl. No.: 10/752,938

(22) Filed: Jan. 6, 2004

(30) Foreign Application Priority Data
Aug. 28, 2003 (IL) 157,625

(51) Int. Cl. C08F 4/44

(52) U.S. Cl. 526/122

(57) ABSTRACT

The invention provides a method for imparting antiviral properties to a hydrophilic polymeric material comprising preparing a hydrophilic polymeric slurry, dispersing an ionic copper powder mixture containing cuprous oxide and cupric oxide in said slurry and then extruding or molding said slurry to form a hydrophilic polymeric material, wherein water-insoluble particles that release both Cu⁺⁺ and Cu⁺ are directly and completely encapsulated within said hydrophilic polymeric material.

The present invention relates to a method for imparting antiviral properties to a hydrophilic polymeric material, to hydrophilic polymeric materials for inactivation of a virus and to devices incorporating the same.

More particularly, the present invention relates to hydrophilic polymeric materials incorporating a mixture of water-insoluble particles that release both Cu⁺⁺ and Cu⁺ wherein said particles are directly and completely encapsulated within said hydrophilic polymeric material.

In WO 01/74166 there is described and claimed an antimicrobial and antiviral polymeric material, having microscopic particles of ionic copper encapsulated therein and protruding from surfaces thereof and the relevant teachings of said publication are incorporated herein by reference.

In said publication it is indicated that the polymeric material can be any synthetic polymer and examples which are mentioned are polyamides (nylon), polyester, acrylic, polypropylene, silastic rubber and latex.

As will be noted however, Example 1 of said patent related to the preparation of a polyamide bi-component compound into which the copper powder was added and the tests for antiviral, antifungal and antibacterial activity were carried out with said fibers.

In Example 4 of said patent, latex gloves were prepared however these were made from latex having microscopic particles of ionic copper protruding from the surfaces thereof.

At the time of the writing of said specification it was believed that all of the polymeric materials listed therein were effective as antimicrobial and antiviral only when the microscopic particles of ionic copper were protruding from the surfaces of the polymeric material as seen e.g. in FIG. 1 of said publication.

According to the present invention it has now been surprisingly discovered that when working with a hydrophilic polymeric material it is possible to produce a material and devices based thereon that possess antiviral properties even though the particles that release both Cu⁺⁺ and Cu⁺ are directly and completely encapsulated within said hydrophilic polymeric material.

In light of this surprising discovery which is neither taught nor suggested in said earlier specification, there is now provided according to the present invention a method for imparting antiviral properties to a hydrophilic polymeric material comprising preparing a hydrophilic polymeric slurry, dispersing an ionic copper powder mixture containing cuprous oxide and cupric oxide in said slurry and then extruding or molding said slurry to form a hydrophilic polymeric material, wherein water-insoluble particles that release both Cu⁺⁺ and Cu⁺ are directly and completely encapsulated within said hydrophilic polymeric material.

In preferred embodiments of the present invention said ionic copper powder mixture is prepared by oxidation-reduction and preferably in the preparation of said ionic copper powder said reduction is carried out using formaldehyde as a reductant.

The invention also provides a hydrophilic polymeric material for inactivation of a virus comprising a mixture of water-insoluble particles that release both Cu⁺⁺ and Cu⁺, which particles are directly and completely encapsulated within said hydrophilic polymeric material and are the primary active component therein.

In preferred embodiments of the present invention said particles are of a size of between about 1 and 10 microns and preferably said particles are present within said hydrophilic material in a concentration of about 1 to 3 w/w %.

As indicated the present invention is specifically directed to imparting antiviral properties to a hydrophilic polymeric material and in preferred embodiments of the present invention said hydrophilic polymeric material is selected from the group consisting of latex:, nitrile, acrylics, polyvinyl alcohol and silastic rubber.

According to the present invention there is also provided a thin hydrophilic polymeric coating comprising said mixture of water-insoluble particles that release both Cu⁺⁺ and Cu⁺, which particles are directly and completely encapsulated within said hydrophilic polymeric coating material and are the primary active component therein.

Such thin layer coatings can be applied on polymeric and other substrates and is especially useful for application to polymers, the polymerization of which might be disrupted by the presence of cationic species of copper and or for the coating of latex polymeric articles wherein sensitivity to latex is problematic, such as in latex gloves and condoms.

Based on the findings of the present invention it is now possible and the present invention also provides a device for the-inactivation of a virus brought in contact therewith, wherein said device is in the form of a nipple or nipple shield formed from a hydrophilic polymeric material comprising a mixture of water-insoluble particles that release both Cu⁺⁺ and Cu⁺, which particles are directly and completely encapsulated within said hydrophilic polymeric material.

The invention also provides a device for the inactivation of a virus brought in contact therewith, wherein said device is in the form of a bag formed from a hydrophilic polymeric material comprising a mixture of water-insoluble particles that release both Cu⁺⁺ and Cu⁺, which particles are directly and completely encapsulated within said hydrophilic polymeric material and preferably said bag is a blood storage bag.

In further preferred embodiments of the present invention there is provided a device for the inactivation of a virus brought in contact therewith, wherein said device is in the form of a tube formed from a hydrophilic polymeric material comprising a mixture of water-insoluble particles that release both Cu⁺⁺ and Cu⁺, which particles are directly and completely encapsulated within said hydrophilic polymeric material.

Preferably said tube is a tube for transfer of body fluids such as blood or milk.

In especially preferred embodiments of said device of the present invention said tube is provided with projections extending into the lumen thereof in order to cause mixing of the fluid flowing therethrough to assure contact of all of said fluid with surfaces of said polymeric material.

In a further aspect of the present invention there is provided a device for the inactivation of a virus brought in contact therewith, wherein said device is in the form of a condom formed from a hydrophilic polymeric material comprising a mixture of water-insoluble particles that release both Cu⁺⁺ and Cu⁺, which particles are directly and completely encapsulated within said hydrophilic polymeric material and are the primary active component therein.

In yet another aspect of the present invention there is provided a device for the inactivation of a virus brought in contact therewith, wherein said device is in the form of a diaphragm formed from a hydrophilic polymeric material comprising a mixture of water-insoluble particles that release both Cu⁺⁺ and Cu⁺, which particles are directly and completely encapsulated within said hydrophilic polymeric material.

The invention also provides a device for the inactivation of a virus brought in contact therewith, wherein said device is in the form of a glove formed from a hydrophilic polymeric material comprising a mixture of water-insoluble particles that release both Cu⁺⁺ and Cu⁺, which particles are directly and completely encapsulated within said hydrophilic polymeric material.

The invention also provides a device for the inactivation of a virus brought in contact therewith, wherein said device is in the form of a glove formed from a hydrophilic polymeric material and coated with a thin layer of a further hydrophilic polymeric material, said further hydrophilic polymeric material comprising a mixture of water-insoluble particles that release both Cu⁺⁺ and Cu⁺, which particles are directly and completely encapsulated within said hydrophilic polymeric material.

In especially preferred embodiments of the present invention there is provided a hydrophilic polymeric material for inactivation of a virus comprising a mixture of water-insoluble particles that release both Cu⁺⁺ and Cu⁺, which particles are directly and completely encapsulated within said hydrophilic polymeric material and are the sole antiviral component therein.

In U.S. patent application Ser. No. 10/339886 corresponding to PCT/IL03/00230, the relevant teachings of which are also incorporated herein by reference there is described and claimed a device for the inactivation of a virus comprising a filtering material, said device having ionic copper selected from the group consisting of Cu⁺ and Cu⁺⁺ ions and combinations thereof incorporated therein.

In said specification there is described the plating of cellulose fibers using a copper solution which results in the formation of copper oxide on the surface of said fibers wherein the process used yields both a Cu(I) and a Cu(II) species as part of a copper oxide molecule. Said fibers were then incorporated into a filter which was found to be effective in the inactivation of HIV-1. Further tests with said filter revealed that this combination was also effective in the inactivation of West Nile fever virus and the neutralization of adenovirus and therefore it is believed that the antiviral hydrophilic polymeric materials of the present invention are also effective against such viruses since they work on the same mechanism.

While the mechanism of the hydrophilic polymeric materials according to the present invention is not fully understood, in light of the results obtained, it is believed that when the polymeric material is brought into contact with a fluid aqueous medium, said medium leaches the cationic species of copper from within said polymer and as described in PCT/IL03/00230 the antiviral activity takes advantage of the redox reaction of the cationic species with water and allows a switch between Cu (II) and Cu (I) when there is contact with water. Cu(I) is more effective than Cu(II) against HIV while Cu(II) is more stable than Cu(I). The Cu(II) compound will oxidize much more slowly than the Cu(I) compound and will increase the shelf life of the product.

As will be realized, in light of the now proven efficacy of cupric ions in the inactivation of HIV, as more fully described in PCT/IL03/00230, the hydrophilic polymeric materials of the present invention can also be used for the solution of at least two major HIV problems which are plaguing the world.

The first of these problems is that in that in the third world countries and especially in African countries entire populations are being decimated by HIV due to the transmission of HIV from infected mothers to their newborn babies via nursing milk.

Due to the poverty prevalent in these countries milk substitutes are not available to newborn and nursing babies and infected mother's milk has been found to be the major cause of transmission of HIV to children.

A further acute problem which also exists in the Western world is the fear of transfusion of HIV contaminated blood.

While blood banks now screen donated blood for HIV antibodies it is known that the test for antibodies is only effective after the incubation period of 60-90 days and therefore there is always the danger that this screening process will not detect the blood of an individual who only contracted HIV within 2 or 3 months of the donation.

Thus, as described hereinbefore, the present invention provides tubes for the transfer of blood and bags for the storage of blood, the surfaces of which are effective for inactivating viruses such as HIV virus. Furthermore, the present invention provides nipples which can be used in breast shields of nursing mothers wherein milk passing therethrough will undergo inactivation of any HIV virus contained therein.

It will be realized that the device and method of the present invention is not limited to the above mentioned preferred uses and that the device can also be used in a hospital or field hospital setting wherein blood from a blood bank is not available and a direct transfusion is mandated in that the preferred tubes of the present invention are provided with projections extending into the lumen thereof in order to cause mixing of the fluid flowing therethrough to assure contact of all of said fluid with surfaces of said polymeric material and thereby blood can be transferred through said tubes which would inactivate any viruses contained in said blood.

In further embodiments of the present invention the devices of the present invention can also be used to inactivate other viruses found in body fluids including the inactivation of West Nile fever which has now been discovered to exist in the blood of carriers of said disease who do not show symptoms thereof however whose blood could contaminate blood banks by transmission of said virus thereto.

As will be realized, once the water insoluble ionic copper compounds are mixed into a hydrophilic polymeric slurry, said slurry can be molded or extruded to form fibers, yarns, films, tubes, sheaths, bags, etc. wherein the water-insoluble particles that release both Cu⁺⁺ and Cu⁺ are directly and completely encapsulated within said hydrophilic polymeric material.

Unlike the fibers described, e.g. in WO 98/06508 and WO 98/06509, in which the fibers are coated on the outside, in the present product the polymer has microscopic water insoluble particles of ionic copper directly and completely encapsulated therein. These fully encapsulated particles have been shown to be active, as demonstrated by the tests set forth hereinafter.

In WO 94/15463 there are described antimicrobial compositions comprising an inorganic particle with a first coating providing antimicrobial properties and a second coating providing a protective function wherein said first coating can be silver or copper or compounds of silver, copper and zinc and preferred are compounds containing silver and copper (II) oxide. Said patent, however, is based on the complicated and expensive process involving the coating of the metallic compositions with a secondary protective coating selected from silica, silicates, borosilicates, aluminosilicates, alumina, aluminum phosphate, or mixtures thereof and in fact all the claims are directed to compositions having successive coatings including silica, hydrous alumina and dioctyl azelate.

In contradistinction, the present invention is directed to the use and preparation of a hydrophilic polymeric material, wherein water-insoluble particles that release both Cu⁺⁺ and Cu⁺ are directly and completely encapsulated within said hydrophilic polymeric material which is neither taught nor suggested by said publication and which has the advantage that the Cu⁺⁺ and Cu⁺ releasing water insoluble particles have been proven to be effective even in the inhibition of HIV-1 activity.

In EP 427858 there is described an antibacterial composition characterized in that inorganic fine particles are coated with an antibacterial metal and/or antibacterial metal compound and said patent does not teach or suggest a hydrophilic polymeric material, wherein water-insoluble particles that release both Cu⁺⁺ and Cu⁺ are directly and completely encapsulated within said hydrophilic polymeric material.

In DE 4403016 there is described a bacteriacidal and fungicidal composition utilizing copper as opposed to ionic Cu⁺⁺ and Cu⁺ and said patent also does not teach or suggest a hydrophilic polymeric material, wherein water-insoluble particles that release both Cu⁺⁺ and Cu⁺ are directly and completely encapsulated within said hydrophilic polymeric material.

In JP-01 046465 there is described a condom releasing sterilizing ions utilizing metals selected from copper, silver, mercury and their alloys which metals have a sterilizing and sperm killing effect, wherein the metal is preferably finely powdered copper. While copper salts such as copper chloride, copper sulfate and copper nitrate are also mentioned as is known these are water soluble salts which will dissolve and break down the polymer in which they are introduced. Similarly, while cuprous oxide is specifically mentioned this is a Cu⁺ ionic form and therefore said patent does not teach or suggest the use of a hydrophilic polymeric material, wherein water-insoluble particles that release both Cu⁺⁺ and Cu⁺ are directly and completely encapsulated within said hydrophilic polymeric material, which has been proven to be effective even in the inhibition of HIV-1 activity.

In JP-01 246204 there is described an antimicrobial moulded article in which a mixture of a powdery copper compound and organic polysiloxane are dispersed into a thermoplastic moulded article for the preparation of cloth, socks, etc. Said patent specifically states and teaches that metal ions cannot be introduced by themselves into a polymer molecule and requires the inclusion of organopolysiloxane which is also intended to provide a connecting path for the release of copper ions to the fiber surface. Thus, as will be realized said copper compound will be encapsulated and said patent does not teach or suggest the use of a hydrophilic polymeric material, wherein water-insoluble particles that release both Cu⁺⁺ and Cu⁺ are directly and completely encapsulated within said hydrophilic polymeric material.

In JP-03 113011 there is described a fiber having good antifungus and hygienic action preferably for producing underwear wherein said synthetic fiber contains copper or a copper compound in combination with germanium or a compound thereof, however, said patent teaches and requires the presence of a major portion of germanium and the copper compounds disclose therein are preferably metallic copper, cuprous iodide which is a monovalent Cu⁺ compound and water soluble copper salts. Thus, said patent does not teach or suggest the use of a hydrophilic polymeric material, wherein water-insoluble particles that release both Cu⁺⁺ and Cu⁺ are directly and completely encapsulated within said hydrophilic polymeric material.

In EP 116865 there is described and claimed a polymer article containing zeolite particles at least part of which retain at least one metal ion having a bacterial property and thus said patent does not teach or suggest the use of Cu⁺⁺ and Cu⁺ releasing water insoluble particles, by themselves and in the absence of a zeolite, which have been proven to be effective even in the inhibition of HIV-1 activity.

In EP 253653 there is described and claimed a polymer containing amorphous aluminosilicate particles comprising an organic polymer and amorphous aluminosilicate solid particles or amorphous aluminosilicate solid particles treated with a coating agent, at least some of said amorphous aluminosilicate solid particles holding metal ions having a bactericidal actions. Thus, said patent does not teach or suggest the use of Cu⁺⁺ and Cu⁺ releasing water insoluble particles, by themselves and in the absence of amorphous aluminosilicate particles, which have been proven to be effective even in the inhibition of HIV-1 activity.

As indicated hereinabove, the hydrophilic polymeric material of the present invention, having microscopic particles of ionic copper directly and completely encapsulated therein, can also be utilized to manufacture disposable gloves and condoms using a mold/form configuration.

In general, the chief raw material is concentrated and preserved natural rubber latex. In addition such chemicals as acid, chlorine gases, alkalis, and corn/maize starch can be added, as is known in the art, however according to the present invention there is also added Cu⁺⁺ and Cu⁺ in powder form.

Formers (or positive molds) are prepared through preparations that will keep the liquid latex from sticking thereto. This is done through a series of dips and treatments to the molds, as known per se in the art. The formers are then cleaned and dried and are dipped into a solution of coagulant chemicals. The coagulant forms a layer on the formers which helps to solidify latex when the formers are dipped into the latex tank.

The formers are dipped into the latex mixture, withdrawn therefrom and passed through a curing oven. The gloves and/or condoms will be vulcanized as they pass through the different areas of the oven which expose the same to temperatures ranging from about 120 to 140° C. This process cross-links the latex rubber to impart the physical qualities required.

The difference between the normal process of manufacturing a disposable glove/condom and the process of the present invention is the addition of water insoluble particles that release Cu⁺⁺ and Cu⁺ in the raw materials.

While the invention will now be described in connection with certain preferred embodiments in the following examples so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, the following examples which include preferred embodiments will serve to illustrate the practice of this invention, it being understood that the particulars shown are by way of example and for purposes of illustrative discussion of preferred embodiments of the present invention only and are presented in the cause of providing what is believed to be the most useful and readily understood description of formulation procedures as well as of the principles and conceptual aspects of the invention.

### EXAMPLE 1

a) An amount of copper oxide powder was produced through a reduction oxidation process as known per se and as described in the aforementioned prior art. In this production formaldehyde was used as the reductant. The resulting powder was a dark brown color indicating a mixture of cupric and cupous oxides.

b) The powder was allowed to dry and was milled down to a particle size of about 4 microns.

c) An amount of bi-component latex was mixed and heated at a temperature of about 150° C. so that it was in a liquid state ready for molding.

d) Three samples were made containing 1%, 2% and 3% by weight of the powder within the latex. More specifically, in sample 1, 1 gram of powder was added to 100 grams of the heated latex slurry, in sample 2, 2 grams of powder were added to 100 grams of the heated latex slurry, and in sample 3, 3 grams of powder were added to 100 grams of the heated latex slurry

e) The resulting slurry was then molded to form a plurality of latex bags.

### EXAMPLE 2

A plurality of bags prepared according to Example 1 were sent to the Ruth Ben-Ari Institute of Clinical Immunology and AIDS Center at the Kaplan Medical Center in Israel for testing.

Method: Aliquots of medium containing HIV were placed in UV sterile Cupron copper-containing latex bags or in UV sterile latex bags not containing copper. Virus stocks that were not exposed to any material served as positive controls for infectivity. As a negative control for viral activity, medium without any virus was placed in the Cupron copper containing bags. After 20 minutes of incubation at room temperature, 50 μl drops from each of the bags were mixed with 40 μl fresh medium containing 10% fetal calf serum (FCS), and each mixture was added to target cells in 1 ml medium containing 10% FCS. The virus-cell mixtures were then incubated in 24 well plates in a CO₂ humidified incubator at 37° C. After four days of incubation the amount of virus present per well was quantified.

Results: No viral infectivity was measured in the medium spiked with virus and exposed to the Cupron copper containing bags or in the non-spiked medium, while the viral infectivity of the medium containing virus and exposed to a latex bag, which did not contain copper, were similar to that of the stock virus used.

Conclusion: The Cupron copper-containing latex bags deactivated the virus.

The results of Example 2 conclusively prove that a device according to the present invention is effective for inactivating viruses in fluids brought in contact therewith and thus e.g. blood storage bags according to the present invention can assure that blood stored therein will not transmit a virus to a recipient of said blood.

With regard to the procedure described in Example 1, as will be realized the same system is applicable to any molding or extrusion process since the water insoluble copper containing compounds are added at the slurry stage. Thus, since the copper compounds are added at this stage of production any product can be made through molding or extrusion including but not limited to gloves, tubes, sheaths, bags, nipple shields, condoms, diaphragms or any desired product.

It is to be noted that the only limitation is that the particle size of the copper compounds must be small enough so as not to disturb the flow of the slurry through extrusion machinery which is the reason for the use of a particle size of about 4 microns in the above process. It is further to be noted that even with the addition of 3% by weight of copper compounds to the latex slurry, there was no discernible difference in the viscosity of the slurry further confirming the versatility of the invention.

The finished product was placed under an electron microscope for observation. No copper oxide particles could be identified by sight or through spectrographic readings on the surface of the molded product which was different than the observations made when the same process was carried out using a polyester polymer.

In the case of a polyester fiber, it was noted that the particles of the copper oxide compound, even when milled down to a 2 micron size, still protruded from the surface of the polymer.

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

1. A method for imparting antiviral properties to a hydrophilic polymeric material comprising preparing a hydrophilic polymeric slurry, dispersing an ionic copper powder mixture containing cuprous oxide and cupric oxide in said slurry and then extruding or molding said slurry to form a hydrophilic polymeric material, wherein water-insoluble particles that release both Cu⁺⁺ and Cu⁺ are directly and completely encapsulated within said hydrophilic polymeric material.

2. A method according to claim 1 wherein said ionic copper powder mixture is prepared by oxidation-reduction.

3. A method according to claim 2 wherein said reduction is carried out using formaldehyde as a reductant.

4. A hydrophilic polymeric material for inactivation of a virus comprising a mixture of water-insoluble particles that release both Cu⁺⁺ and Cu⁺, which particles are directly and completely encapsulated within said hydrophilic polymeric material and are the primary active component therein.

5. A hydrophilic polymeric material for inactivation of a virus according to claim 4 wherein said particles are of a size of between about 1 and 10 microns.

6. A hydrophilic polymeric material for inactivation of a virus according to claim 4 wherein said particles are present within said hydrophilic material in a concentration of about 1 to 3 w/w %.

7. A hydrophilic polymeric material for inactivation of a virus according to claim 4, wherein said hydrophilic polymeric material is selected from the group consisting of latex, nitrile, acrylics, polyvinyl alcohol and silastic rubber.

8. A device for the inactivation of a virus brought in contact therewith, wherein said device is in the form of a nipple or nipple shield formed from a hydrophilic polymeric material comprising a mixture of water-insoluble particles that release both Cu⁺⁺ and Cu⁺, which particles are directly and completely encapsulated within said hydrophilic polymeric material.

9. A device for the inactivation of a virus brought in contact therewith, wherein said device is in the form of a bag formed from a hydrophilic polymeric material comprising a mixture of water-insoluble particles that release both Cu⁺⁺ and Cu⁺, which particles are directly and completely encapsulated within said hydrophilic polymeric material.

10. A device for the inactivation of a virus brought in contact therewith according to claim 9 wherein said bag is a blood storage bag.

11. A device for the inactivation of a virus brought in contact therewith, wherein said device is in the form of a tube formed from a hydrophilic polymeric material comprising a mixture of water-insoluble particles that release both Cu⁺⁺ and Cu⁺, which particles are directly and completely encapsulated within said hydrophilic polymeric material.

12. A device for the inactivation of a virus brought in contact therewith according to claim 11 wherein said tube is a tube for transfer of body fluids.

13. A device according to claim 12 for the inactivation of a virus contained in a fluid flowing therethrough wherein said tube is provided with projections extending into the lumen thereof in order to cause mixing of the fluid flowing therethrough to assure contact of all of said fluid with surfaces of said polymeric material.

14. A device for the inactivation of a virus brought in contact therewith, wherein said device is in the form of a condom formed from a hydrophilic polymeric material comprising a mixture of water-insoluble particles that release both Cu⁺⁺ and Cu⁺, which particles are directly and completely encapsulated within said hydrophilic polymeric material and are the primary active component therein.

15. A device for the inactivation of a virus brought in contact therewith, wherein said device is in the form of a diaphragm formed from a hydrophilic polymeric material comprising a mixture of water-insoluble particles that release both Cu⁺⁺ and Cu⁺, which particles are directly and completely encapsulated within said hydrophilic polymeric material.

16. A device for the inactivation of a virus brought in contact therewith, wherein said device is in the form of a glove formed from a hydrophilic polymeric material comprising a mixture of water-insoluble particles that release both Cu⁺⁺ and Cu⁺, which particles are directly and completely encapsulated within said hydrophilic polymeric material.

17. A device for the inactivation of a virus brought in contact therewith, wherein said device is in the form of a glove formed from a hydrophilic polymeric material and coated with a thin layer of a further hydrophilic polymeric material, said further hydrophilic polymeric material comprising a mixture of water-insoluble particles that release both Cu⁺⁺ and Cu⁺, which particles are directly and completely encapsulated within said hydrophilic polymeric material.

18. A hydrophilic polymeric material for inactivation of a virus comprising a mixture of water-insoluble particles that release both Cu⁺⁺ and Cu⁺, which particles are directly and completely encapsulated within said hydrophilic polymeric material and are the sole antiviral component therein.

19. A hydrophilic polymeric material for inactivation of a virus according to claim 18 wherein said polymeric material is in the form of a film.
